(19) United States
(12) Patent Application Publication
(10) Pub. No.: US 2005/0193885 A1
(43) Pub. Date: Sep. 8, 2005

(54) Automatic pill cutter

(76) Inventor: Mark Lykam, Livermore, CA (US)

Correspondence Address: US CORPORATIONS, INC., 630 NEPTUNE AVE., ENCINITAS, CA, 92024, US

(21) Appl. No.: 10/796,490

(22) Filed: Mar. 4, 2004

(51) Int. Cl. B26F 3/00

(52) U.S. Cl. 83/697; 225/103

(57) ABSTRACT

An automatic pill cutter, including a solenoid plunger, torsion spring, indexing wheel, and cutting blade mounted within an upper and lower body assembly capable of cutting pills ranging in size up to 0.187 inches in thickness and 0.500 in diameter.

### CROSS-REFERENCE TO RELATED APPLICATION

Not applicable

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

### FIELD OF THE INVENTION

### NEED HISTORY

### SUMMARY OF THE INVENTION

### DESCRIPTION

This invention relates generally to an improved pill cutter and more particularly to a pill cutter for simultaneously cutting any shape of pills. More particularly, it relates to a pill cutter which can function both to cut simultaneously and to serve as an easily adjustable pill cutter which can easily change for shape or diameter.

It is generally well-known that on numerous occasions, particularly with respect to children, that a half or a quarter of a pill is prescribed. Normally, in such an event, an attempt is made to divide the pill by placing it on a support surface and then attempting to cut or split the pill with a sharp instrument such as a knife. Generally, this results in the pill or the pieces thereof being scattered about the immediate area. Anyone who has attempted to split a pill in half, or a quarter, will readily attest to these facts.

Accordingly, it is an object of the present invention to provide an improved pill cutter for cutting pills.

Generally the pill cutter of the present invention is of a relatively simple construction, including the indexing wheel and torsion fingers (LH and RH) are which are critical to centering the pill each time it is cut. The indexing wheel also it holds a variety of sizes and pushes the pill out after it is cut.

The indexing wheel of the present invention also serves multiple uses such as centering the pill and stabilizing the pill or holding it, as the blade moves upward and downward.

Removing or changing the indexing wheel in the present invention is simple and quick as it is held down with only a thumb screw. Another unique feature of the present invention is to center and cut the pill automatically after it is simply set on the track and fed in to the device.

In U.S. Pat. No. 4,173,826 there is disclosed a pill cutter for cutting a pill in half or a quarter. A pill cutter of the type disclosed therein functions very satisfactorily in cutting individual pills one at a time. In many cases, however, it is desired to cut a different shape or diameter without time consuming equipment changes.

Accordingly, it is an object of the present invention to provide a pill cutter which can cut most shapes and diameters of pills.

Further, it is an object of the present invention to cut pills ranging in diameter from ⅛ to ½ inch without replacing any parts.

Further still, it is an object to provide such a pill cutter which directs the cut pills so that they can be collected at one point.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new automatic pill cutting device apparatus and which has many of the advantages of the devices mentioned heretofore and many novel features that result in an automatic pill cutting device which is not anticipated, rendered obvious, suggested, or even implied by any of the prior art tool guides, either alone or in any combination thereof.

It is another object of the present invention to provide a new automatic pill cutting device which may be easily and efficiently manufactured and marketed.

It is a further object of the present invention to provide a new data port plug device which is of a durable and reliable construction.

An even further object of the present invention is to provide a new data port plug device which is susceptible of a low cost of manufacture with regard to both materials and labor, and which accordingly is then susceptible of low prices of sale to the consuming public, thereby making such dimmable light therapy devices economically available to the buying public.

Still yet another object of the present invention is to provide a new data port plug device which provides in the apparatuses and methods of the prior art some of the advantages thereof, while simultaneously overcoming some of the disadvantages normally associated therewith.

Yet another object of the present invention is to provide a new data port plug device which includes a molded latch, molded cover and molded shaft assembly.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### ILLLUSTRATIONS

A perspective view of the present invention as viewed herein;

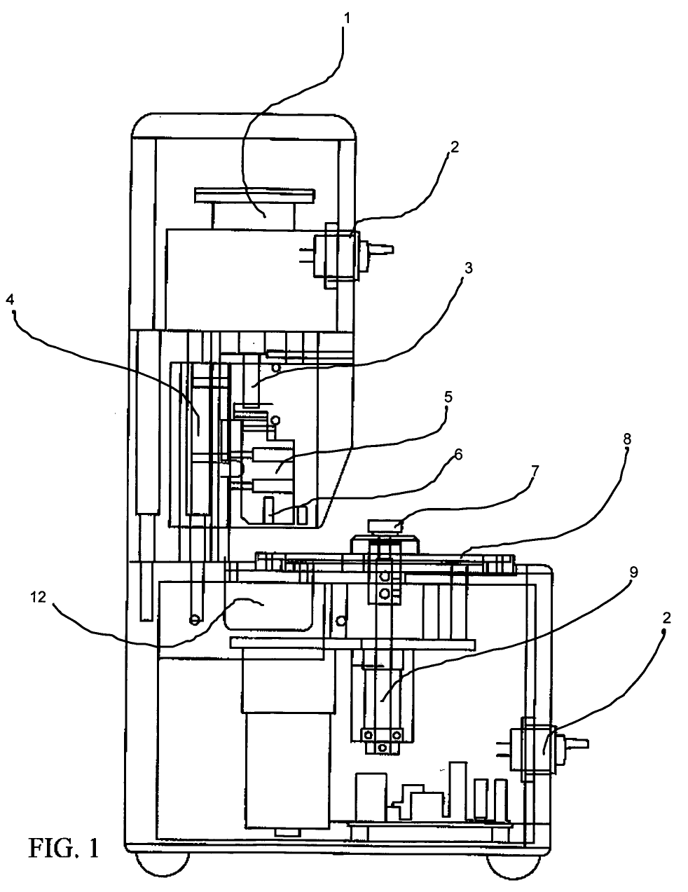

FIG. 1 is a perspective view of the left side of the invention developed for cutting pharmaceutical pills. FIG. 1, numeral 1, is a perspective view of the solenoid which moves the plunger (2) down pushing the blade housing (5) attached to the slide (4) which stabilizes the cutting blade placed in the blade slot (6). The pharmaceutical pills are rotated by the indexing wheel (8) which is held into place by the thumb screw (7) connected to the indexing wheel shaft (9) and activated with the front, lower power switch (2).

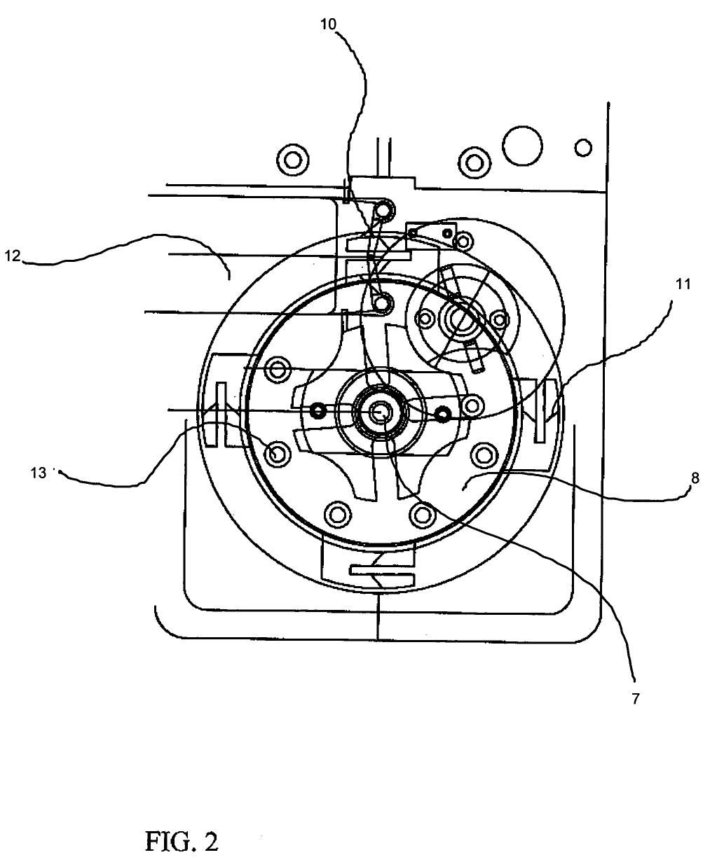

FIG. 2 represents the topographical view of the indexing wheel (8) and its related functional parts. The pills are collected within the indexing wheel after being shaken by the vibration pads (13) and gathered in the cutting groove (11) and taken to the torsion fingers (10) where they are centered and cut. After the pill is cut the sum of its parts will travel down the pill slide (12) and collected.

1. An automatic, self centering pharmaceutical pill cutting device with an adjustable indexing wheel and torsion fingers for centering before cutting.

2. An automatic pharmaceutical pill cutting device, according to claim 1 wherein the pill is centered in the indexing wheel by a right and left hand torsion fingers.

3. An automatic pharmaceutical pill cutting device, according to claim 1 wherein the torsion fingers spring back and allow the ½ inch pill to pass through and exit

4. An automatic pharmaceutical pill cutting device, according to claim 1 wherein the indexing wheel holds pillsdown and in place after it is cut.

5. An automatic pharmaceutical pill cutting device, according to claim 1 wherein the indexing wheel handles multiple pill sizes without change of wheel itself.

6. An automatic pharmaceutical pill cutting device, according to claim 1 wherein the indexing wheel can be reconfigured in different shaped pills.

7. An automatic pharmaceutical pill cutting device, according to claim 1 wherein the solenoid that activates the blade up and down can cut pills ranging up to 0.187 in thickness and 0.500 diameter.

8. An automatic pharmaceutical pill cutting device, according to claim 1 wherein the vibration pads will not cause the pills to jump prior to cutting.
